(19) United States
(12) Patent Application Publication
(10) Pub. No.: US 2013/0047932 A1
(43) Pub. Date: Feb. 28, 2013

(54) RAWHIDE WRAPPED ROPE CHEW TOY

(71) Applicants: Barbara Salmon Hyder, Norfolk, VA (US); John Cummings, West Babylon, NY (US)

(72) Inventors: Barbara Salmon Hyder, Norfolk, VA (US); John Cummings, West Babylon, NY (US)

(21) Appl. No.: 13/215,714

(22) Filed: Aug. 23, 2011

(51) Int. Cl. A01K 29/00

(52) U.S. Cl. 119/710

(57) ABSTRACT

An animal chew toy where ribbon-shaped rawhide is wrapped around twisted or braided natural fibre rope with each twist of the rawhide around the rope being spaced apart from the previous twist of rawhide and the rawhide wrapped rope being tied in a knot to prevent unraveling of the rope.

### FIELD OF INVENTION

The present invention relates to chew toys for domesticated animals. In particular, rawhide is treated so as to be pliable and then wrapped around a twisted or braided rope, with the ends of the rope being tied off to prevent unraveling of the rawhide wrapped rope.

### BACKGROUND OF THE INVENTION

Chew toys are designed to be chewed by animals for purposes of stimulation and relief from boredom. There are several different types of chew toys, including rawhide, wood, paper and mineral. Chew toys are commonly associated with puppies and dogs, although they may also be used for cats, birds, rodents, and rabbits.

Chew toys are a vital part of a happy and healthy animal's life. In addition to providing hours of entertainment, they also allow the animal to work out anxiety and boredom by being occupied with chewing a toy. Chew toys also distract small animals from chewing on other “forbidden” items, and they assist in maintaining healthy teeth.

Rawhide is the inner layer of the hide of any cleft-hoofed bovine livestock. In making rawhide, the animal's skin is split into inner and outer layers. The tough outer layer is used for leather shoes, garments, upholstery and the like. The softer inner layer is washed and cleaned. The hides are then cut, formed and dried into may varieties of rawhide. Rawhide is tough yet relatively flexible due to the linking of collagen fibers that stiffen when it dries out. As the animal chews the rawhide, the saliva from the animals mouth moistens and softens the rawhide. Rawhide tends to contain mostly protein with smaller amounts of fiber, moisture and fat.

Rawhide chew toys are most often associated with puppies and dogs. Rawhide is suitable for all animals except herbivores, as it is made of animal skin. This is a rather sturdy kind of chew toy and it can take months for a small animal or bird to destroy. Examples of rawhide chew toys are twists and rawhide bones. Compressed rawhide can dangerously splinter when dry as well as break off in large pieces that may be ingested, and thus are generally not recommended for large breeds of dogs.

During the feeding process for animals, they sink their teeth into the rawhide and pull away from it, attempting to strip the rawhide. This provides the beneficial action of tugging and pressure on the teeth and gums of the animal. This tends to toughen the gums and clean the teeth of the animal thereby promoting oral hygiene for the animal. For example, the moistened and chewed rawhide rubs against the teeth of the animal to remove plaque. The rawhide also satisfies the inherent desire to chew that occurs in some animals such as dogs, and in particular in puppies.

A rope is a length of fibres, twisted or braided together to improve strength for pulling and connecting. It has tensile strength but is too flexible to provide compressive strength (i.e. it can be used for pulling, but not pushing). Rope is thicker and stronger than similarly constructed cord, line, string, and twine. Rope has been used as a toy for interactive play with animals, and most commonly with dogs. Dogs grip the rope with their teeth and pull on the rope in a struggle with the person holding the rope. Aside from the entertainment value of the rope, the gripping and struggling action causes friction or rubbing of the animals teeth and gums which promotes oral health for the animal, similar to the action that occurs in the chewing of rawhide. Common materials for rope include natural fibres such as manila hemp, hemp, linen, cotton, coir, jute, and sisal. The use of natural fibres is preferable for use with animals, as opposed to man-made fibres, because of the possibility of the animal ingesting some of the fibres. Ingestion of natural fibres is generally less of a health problem than the ingestion of man-made fibres.

### BRIEF DESCRIPTION OF THE DRAWINGS

The foregoing and other features of the present invention will be more readily apparent from the following detailed description and drawings of illustrative embodiments of the invention in which:

FIG. 1 is a perspective view of the rawhide braided chew toy in accordance with one embodiment of the invention;

FIG. 2 is an end view of the rawhide braided chew toy in accordance with one embodiment of the invention;

FIG. 3 is an side view of the rawhide braided chew toy in accordance with one embodiment of the invention; and

FIG. 4 shows a perspective view of another embodiment of the rawhide braided chew toy.

### DETAILED DESCRIPTION OF THE PREFERRED EMBODIMENTS

Various embodiments now will be described more fully hereinafter with reference to the accompanying drawings, which form a part hereof, and which show by way of illustration, specific embodiments. However, this invention may be embodied in many different fauns and should not be construed as limited to the embodiments set forth herein. Rather, these embodiments are provided so that this disclosure will be thorough and complete, and will fully convey the scope of the invention to those skilled in the art. The following detailed description is not to be taken in a limiting sense.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The present invention relates to an animal chew toy where ribbon-shaped rawhide is wrapped around twisted or braided natural fibre rope with each twist of the rawhide around the rope being spaced apart from the previous twist of rawhide. The ends of the rawhide-wrapped rope are tied with a knot to prevent unraveling.

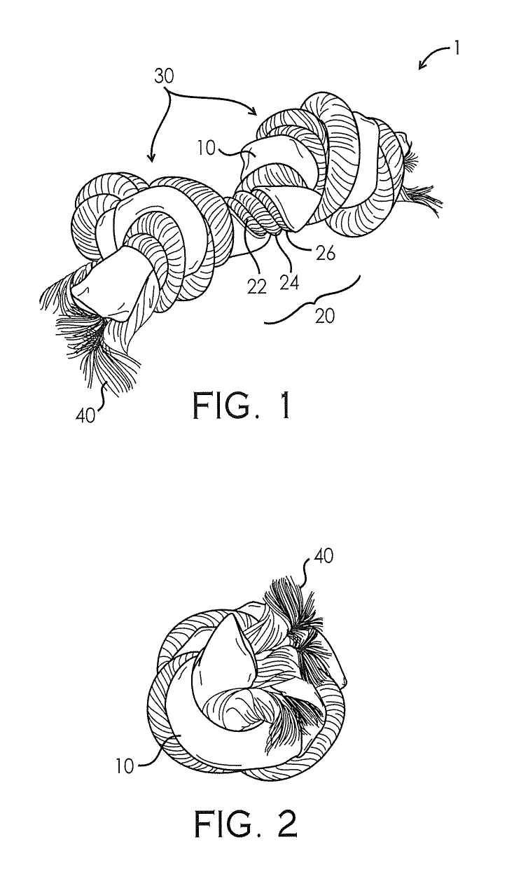

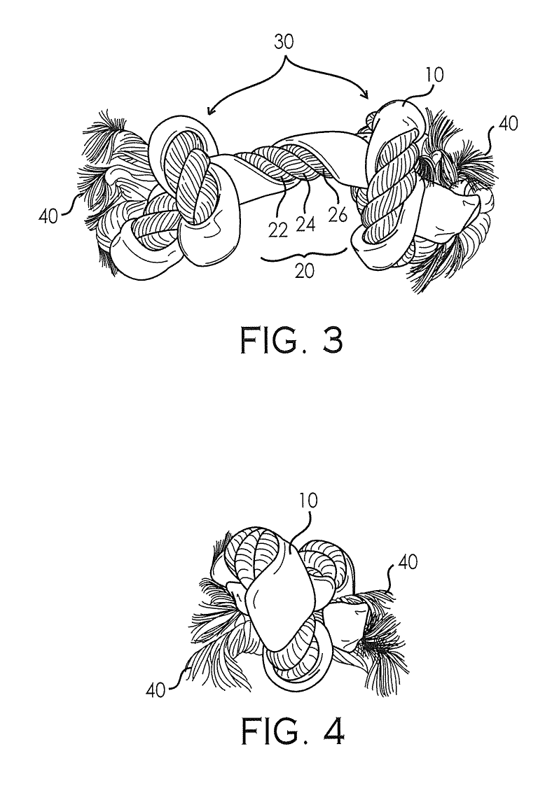

As shown in FIGS. 1 through 3, rawhide wrapped animal chew toy 1 is formed from rawhide 10 being wrapped around rope 20, the entirety of which is then tied in overhand knots 30 at each end, which frayed end section 40 emerging from each end.

Rope 20 is preferably made from a natural fibre that is either twisted or braided together, and may be made of any of various thicknesses. In one embodiment, the rope is made from three ½ inch diameter braids 22, 24, 26 that are twisted together to form rope 20 of approximately a 1 inch diameter. In another embodiment, the braids may be ¼ inch that are twisted or braided together to form a ½ inch diameter rope. Rawhide 10 is selected and sized in accordance with the size of the rope. In one embodiment, the rawhide has a 1¼ inch width and slightly less than a ¼ inch thickness for wrapping around a rope with a 1 inch diameter. In another embodiment, the rope has a ¾ inch width and ⅛^{th} inch thickness for wrapping around a ½ inch rope.

Rawhide 10 is wrapped around the length of the rope, generally following the same rate of twisting as the braids. This provides a space between subsequent twists of the rawhide, typically equaling twice the diameter of the individual braids. During the manufacturing process the rawhide is moistened, wrapped around rope 20, a knot is placed in the rope as appropriate and then the rawhide is dried into shape. This makes the rawhide stiff in its wrapped configuration, and difficult to remove from the rope. By following the contours of the braids, the rawhide is contoured to the shape of the rope and/or contoured to the individual braids next to which it is placed. In one embodiment, the rawhide wraps partially around braids 22, 24 or 26. In an alternative embodiment, the rawhide may replace one of the braids in the twisted or braided rope. The knotting of the rawhide wrapped rope prevents the animal from easily unwrapping the rawhide or the rope. In one embodiment, the rawhide wrapped rope is one to two feet in length for the 1 inch rope with a knot in each end as shown in FIGS. 1 through 3. In another embodiment, the rawhide wrapped rope is knotted once with frayed end sections 40 at each side of knot 30. In yet another embodiment, nutritional additives and flavorants may be added to either the rawhide or rope for the benefit of the animal.

The configuration of the product provides chewing enjoyment for the animal because the animal will try to chew or gnaw on the rawhide and/or knot to try to work it free. In the embodiment with a knot on each end, rawhide wrapped animal chew toy 1 may be held on one end and used as an interactive chew toy with the animal.

While the invention has been particularly shown and described with reference to preferred embodiments thereof, it will be understood by those skilled in the art that various changes in form and details may be made therein without departing from the spirit and scope of the invention.

What is claimed as new and desired to be protected is:

1. An animal chew toy comprising:
a length of three strand twisted natural fibre rope;
a length of rawhide shaped into a ribbon with a width greater than the sum of diameters of two of the three strands forming the natural fibre rope and a thickness equal to or less than a diameter of one of the three strands forming the natural fibre rope;
the length of rawhide wrapped around the three strand twisted natural fibre rope with a space between successive turns of at least the diameter of one of the three strands forming the natural fibre rope; and
the rawhide wrapped three strand twisted natural fibre rope having at least one knot.

2. The animal chew toy of claim 1 wherein the natural fibre rope is comprised of 100% cotton.

3. The animal chew toy of claim 1 further comprising:
An overhand knot at each end of the length of rawhide wrapped three strand twisted natural fibre rope.

4. An animal chew toy comprising:
a length of rope having three or more strands of natural fibre with each strand having a diameter;
a length of ribbon-shaped rawhide having a width greater than twice the diameter and a thickness approximately equal to or less than the diameter;
the length of ribbon-shaped rawhide wrapped around the length of rope with a space between successive turns; and
the rawhide wrapped three strand natural fibre rope tied into a knot.

5. The animal chew toy of claim 4 wherein the rope is either twisted or braided.

6. The animal chew toy of claim 4 wherein the natural fibre rope is comprised of 100% cotton.

7. The animal chew toy of claim 4 further comprising:
An overhand knot at each end of the length of rawhide wrapped three strand natural fibre rope.

8. The animal chew toy of claim 4 further comprising:
A nutritional additive impregnated into the ribbon-shaped rawhide or natural fibre rope.

9. The animal chew toy of claim 4 further comprising:
A flavorant impregnated into the ribbon-shaped rawhide or natural fibre rope.
